(19) United States
(12) Patent Application Publication
(10) Pub. No.: US 2015/0310505 A1
(43) Pub. Date: Oct. 29, 2015

(54) METHOD FOR PROMOTING CONTENT

(71) Applicants: Anton SOLODIKOV, Orenburg (RU); Pavel SHAROV, Orenburg (RU)

(72) Inventors: Anton SOLODIKOV, Orenburg (RU); Pavel SHAROV, Orenburg (RU)

(21) Appl. No.: 14/648,050

(22) PCT Filed: Nov. 29, 2013
(86) PCT No.: PCT/EA2013/000016

§ 371 Date: May 28, 2015

(30) Foreign Application Priority Data
Nov. 30, 2012 (RU) 201201626

(51) Int. Cl. G06Q 30/02

(52) U.S. Cl. CPC G06Q 30/0277; G06Q 30/0273

(57) ABSTRACT

The invention relates to methods for distributing selected content and to data processing systems which consist in a user connecting, via a network by means of a user device, to a Web resource of a content distributor in order to obtain distributable content, and can be used by content distributors and network users for the promotion (distribution) of content. The claimed invention has the effect of expediting, simplifying and facilitating interaction between users and the Web resources of content distributors during user distribution and receipt of selected content as a result of the automatic distribution of distributable content to a plurality (more than one) of user Web resources simultaneously. According to the invention, a functional element is situated on the Web resource of a content distributor; once said functional element is activated by a user, the Web resource of the content distributor connects to a database containing the parameters of Web resources to which said user has administrative access, and automatically publishes the content selected by the user on a plurality (more than one) of the user's Web resources according to the parameters in the database.

### FIELD OF THE INVENTION

The Invention relates to methods for distributing selected content and to data processing systems, intended for content promotion (distribution), which consists in user connecting, via network by means of a user device, to the webresource of the content distributor and can be used by the network users for content promotion.

### BACKGROUND OF THE INVENTION

In the Internet, various sites publish information on their pages that often is of interest for users, including those of social networks, blogs, forums, communities, and otherwise user unions, and some users often want to share said information with other social network users due to their common interest and desire to share said information and, for example, for remuneration paid for internet-content promotion by owners of sites being promoted. For that purpose there are special buttons provided on the sites (such as ‘share’, ‘like’, etc.) which ensure the possibility of site information distribution by random and specially selected users by way of clicking said buttons by means of buttons of keyboard, mouse, etc. After clicking said buttons some information from the site is published on special users' pages in Users Communities, social networks, personal blogs, personal and other sites accompanied with comments of the users ore without one.

Some sites pay remuneration to the users in the form of money, points, bonus points, discounts for goods/services for distribution of information, or otherwise stimulate the Internet users to distribute information from their pages by the above method. Payment is performed with the help of the Internet payment systems or in other ways when the remuneration is not paid in the form a money.

To simplify the procedure, there exist internet-content promotion automation blocks (such as so-called link-exchange market), which are on the one side connected to one or more servers where the resources being promoted are stored, and on the other side - to one or more servers where one or more social networks containing users' pages or personal sites is located.

Solutions for content distribution in the network, such as the Internet, are well known in the art, wherein the solutions make use of a data repository containing information on target recipients of the content and an automation block connected thereto, which allows the users to distribute the content throughout the network provided they have passed certain registration procedures on the certain resource.

Document WO 2012082318 A1 (FACEBOOK INC ET AL), GO6Q 30/00 of Jun. 21, 2012, discloses distribution of target advertising proposals with respect to user's friends (within the network), wherein the user interacts with objects that in either way relate to the said advertising proposal. This document stipulates, that when the users in either way interact with the objects relating to the advertisement, the social network determines relevant advertising proposals based on user's ‘social history’ by viewing user friends' profiles in order to detect similar interests that in either way relate to the content being advertised.

The disadvantage of this solution is the limited functionality of the system for content distribution because the content is realized within a single social network only.

Document US 2011270692 A1 (OPANGA NETWORKS INC), GO6Q 30/00, of Nov. 3, 2011, which was taken as a prototype and disclosing method and system for digital content distribution in social networks with the application of ‘viral marketing’ principle, is known in the art. The solution consists in registration of the first users of the social network on the content provider site to be signed up for the content of interest; then, the first users who have received the said content send their social network friends (second users) proposals advertising the received content with the possibility of content ranging and adding recommendations related thereto.

The disadvantage of this solution is the limited functionality of the system for content distribution because the content is realized within a single social network only, and it lacks content distribution automation procedure.

### Disclosure of the Invention

Based on this original observation, this Invention generally aims at provision of content distribution method allowing for at least mitigation of the above disadvantage, i.e. ensure speeding, simplification, and facilitating the interaction of users with the web resources of content distributors during distribution and receipt by the users of the selected content due to automatic allocation of the content being distributed to several (more than one) users' web resources simultaneously.

Technical result of the claimed Invention is speeding, simplification, and facilitating the interaction of users with the web resources of content distributors during distribution and receipt by the users of the selected content due to automatic allocation of the content being distributed to several (more than one) users' web resources simultaneously.

To achieve this goal a functional element is located on the content distributor web resource, after which activation by the user the distributor web resource addresses to a database containing user's web resources parameters which the user is permitted to control and automatically publishes the content selected by the user on several (more than one) user's web resources according to the database parameters.

Due to this feature, there emerges an opportunity to attract any users of any networks, blogs, forums, etc. or those having visited sites with their own viewership and to propose them to participate in distribution of content distributor content, including on the terms of material incentive. In addition, there emerges a possibility by activation of the very one module, i.e. functional element in the form of, for example, a button located on the content distributor resource:

to allocate the content being distributed on all user's resources simultaneously;

to provide the user with the opportunity to comment the content adding the distribution procedure with non-advertising features, if necessary;

to automate both these procedures and, if necessary, the process of material motivation of the user, such as paying him/her material remuneration.

In one embodiment, the user may be charged remuneration after publishing the selected content.

Due to this advantageous feature, there appears a possibility to increase the efficiency of content distribution.

In other embodiment, activation by the user of the functional element is performed by means of keyboard, mouse, touch-screen, trackball, stylus pen, stylus, touch-pad, joystick, stain-gauge joystick, game-pad, or remote control.

Due to this advantageous feature, there appears an opportunity to provide multivariate activation of the functional element, which ensures facilitation of interaction of users with the web resources of content distributors during distribution and receipt by the users of the selected content.

As a network one of the following may be used: Internet, Fidonet, Tor, local network, campus network, municipal network, global network, telephone network, cellular network, cable network, wireless network, nameless network, file-sharing network, satellites network.

As a web resource on which the user can publish the distributed content of content distributor, user's page in social network may be used that is intended for publishing records on behalf of the user, as well as web site, social network, account in social network, personal profile, blog, microblog, electronic mass media means, internet portal, internet store, message board, web site catalogue, browsing service, mailing service, web forum, blog service, file-sharing service, cloud data repository, data editing service, photo hosting, video hosting, social bookmarking service, social catalogue, social library, geosocial network, information system, internet program, site editor, content management system, forum (blog, conference) branch, channel on video hosting resource, electronic advertisement, message in chat, or comment.

As a functional element located on the web resource of the content distributor, one of the following may be used: button, checkbox, pictogram, text character, word, text, mark, icon, list, menu, dialogue box, modal box, panel, tab, scroll bar, slider bar, status line, pop-up tip, widget, banner, plugin, image, picture, photo, or video.

As a user device, one of the following may be used: personal computer, mobile computer, laptop, tablet computer, internet tablet, e-book, mobile internet-device, mobile phone, cellular phone, satellite phone, touch-sensitive smartphone, PlayStation, game console, or television game device.

Activation by the user of the functional element may be performed by means of keyboard, mouse, touch-screen, trackball, stylus pen, stylus, touch-pad, joystick, stain-gauge joystick, game-pad, or remote control.

As a remuneration charged to the user, the following may be used: money, points, discounts, coupons, bonus points, bonuses, electronic money, electronic currency, cryptocurrency, digital currency, pips, prizes, tokens, medals, awards, diplomas, brownie points, badges of honour, valuable gifts, certificates of appreciation, or honorary degrees.

The remuneration may be automatically charged and transferred to the user and paid to the personal identifier, such as e-wallet, personal account, digital account, personal bank account, client account, personal account, member account, personal profile, personal web page, as well as in kind, in nature, or in monetary equivalent.

### BRIEF DESCRIPTION OF DRAWINGS

Other distinctive features and advantages of the Invention expressly appear from the below non-limiting description of illustration with reference to the accompanying drawing, where:

FIG. 1 is a schematic illustration of the functional scheme of the system implementing the content distribution method of the Invention.

FIG. 2 is a schematic illustration of step sequence of the method of the Invention.

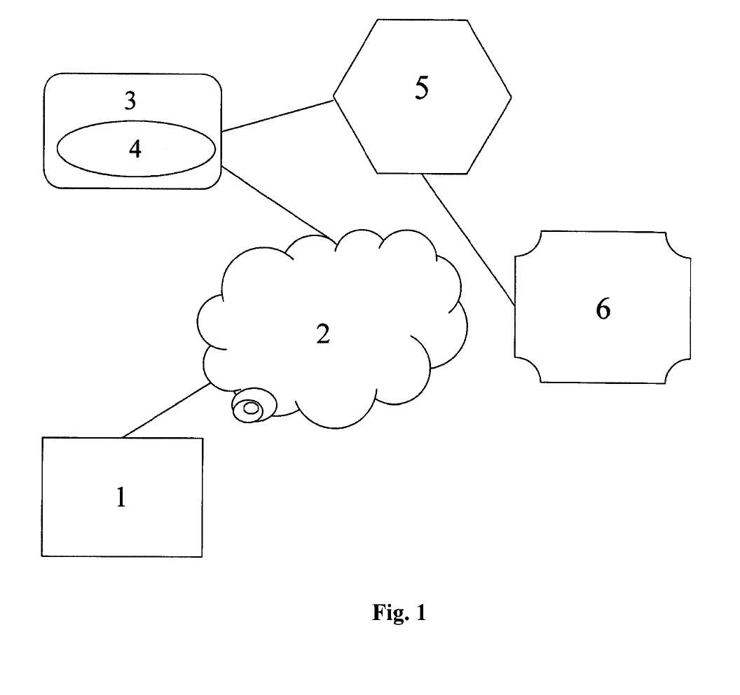

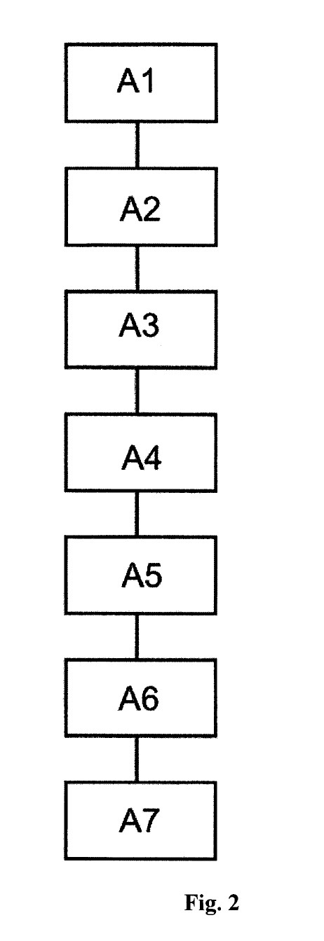

Positions in FIG. 1 illustrate:
1—user device;
2—network;
3—content distributor resource;
4—functional element;
5—database containing resources parameters for content distribution;
6—resource for publishing of the content being distributed

According to FIG. 1, the content distribution method consists in user connecting via network 2 by means of a user device 1, to a web resource 3 of the content distributor to get content distributer content being distributed. Web resource 3 of content distributor addresses to database 5 containing parameters of the web resources where the user can publish content distributor content being distributed.

Web resource of the content distributor contains functional element 4 which at activation by the user automatically generates the distributed content of the content distributor according to the parameters of the web resources contained in the database 5 and publishes the distributed content of the content distributor on several (more than one) web resources 6, where the user can publish the distributed content of the content distributor.

The user devices 1 may be represented, without limitation, by personal computer, mobile computer, laptop, tablet computer, internet tablet, e-book, mobile internet-device, mobile phone, cellular phone, satellite phone, touch-sensitive smartphone, PlayStation, game console, or television game device.

Internetwork by which signal transmission takes place includes different topologies, configurations and arrangements of components of interconnection configured to interconnect corporate, global and local computer networks, and includes, without limitation, custom cable, wireless, satellite, optical and identical network technologies, which should be obvious for specialists of ordinary skills in the art.

The web resource 3 of the content distributor may be represented, without limitation, by web site, social network, account in social network, personal web page, personal profile, blog, microblog, electronic mass media means, internet portal, internet store, message board, web site catalogue, browsing service, mailing service, web forum, blog service, file-sharing service, cloud data repository, data editing service, photo hosting, video hosting, social bookmarking service, social catalogue, social library, geosocial network, information system, internet program, site editor, content management system, forum, blog or conference branch, channel on video hosting resource, electronic advertisement, message in chat, or comment with a functional element locate thereon.

The functional element 4 that may be activated by the user may be represented, without limitation, by button, checkbox, pictogram, text character, word, text, mark, icon, list, menu, dialogue box, modal box, panel, tab, scroll bar, slider bar, status line, pop-up tip, widget, banner, plugin, image, picture, photo, or video.

Activation may be performed, without limitation, by means of keyboard, mouse, touch-screen, trackball, stylus pen, stylus, touch-pad, joystick, stain-gauge joystick, game-pad, or remote control.

The web resources 6 of the user may be represented, without limitation, by web site, social network, account in social network, personal web page, personal profile, blog, microblog, electronic mass media means, internet portal, internet store, message board, web site catalogue, browsing service, mailing service, web forum, blog service, file-sharing service, cloud data repository, data editing service, photo hosting, video hosting, social bookmarking service, social catalogue, social library, geosocial network, information system, internet program, site editor, content management system, forum, blog or conference branch, channel on video hosting resource, electronic advertisement, message in chat, or comment where the user is permitted to publish the content being distributed being the owner, administrator, moderator of the web resource or, alternatively, having access to management thereof.

At activation by the user of the functional element located on the content distributor web resource, the request for automatic generation of the content being distributed is forwarded and transmitted to the user web resources, during which the user may be provided with option to comment on the content being distributed as well as to change and edit the content being distributed, wherein the content being distributed which is provided to the user is represented in the form suitable for web resources where it will be published by the user, according to the parameters contained in the database 5 of the web resources where the user is permitted to publish the content being distributed.

Following the allocation (publishing) of the distributed content on the resources where the user can publish the content being distributed, the user may be charged the remuneration for content distribution.

The remuneration may be represented, without limitation, in the form of money, points, discounts, coupons, bonus points, bonuses, electronic money, electronic currency, cryptocurrency, digital currency, pips, prizes, tokens, medals, awards, diplomas, brownie points, badges of honour, valuable gifts, certificates of appreciation, or honorary degrees, wherein the resource of the content distributor may be automatically connected to the user account for charging and paying the remuneration.

Thus, this method allows to implement the function of automatic allocation of the content being distributed by the user via the web resource of the content distributor by activation of the functional element located on the web resource of the content distributor due to the fact that the user in advance indicates the resources where he/she can publish the content being distributed, information on which is stored in the associated database of the content distributor.

Therefore, the user does not need to publish interesting content on, for example, own pages in social networks, manually, performing the same operation many times, as the web resource of the content distributor automatically generates the content being distributed to be automatically published on all preset web resources of the user with possible further remuneration of the user, which can further motivate the user to distribute the content.

### Implementation of the Invention

Step A1. A user is willing to participate in the content distribution using his/her user device 1 via network 2 visits a web page of a content distributor (content distributor resource 3).

Step A2. The user commences participating in content distribution by activating a functional element in the form of, for example, button 4 embedded in the web page of the content distributor.

Step A3. Optionally, the user may be showed the terms and conditions on which distributed content publishing should take place, such as, the necessity to leave a comment.

Step A4. If the user accepts the terms and conditions or they are missing, the request for participation in content distribution is automatically processed by the functional element in the form of button 4, for example.

Step A5. Distribution of the content being distributed takes place on several (more than one) user web pages, where the user can publish the content being distributed (resources 6 for publishing the content being distributed).

Step A6. As a further option to the functional of the Invention, in the case of remuneration of the user for the content distribution, to charge the remuneration user's personal identifier, such as his/her reference account, is recorded (copied, transferred, saved) in the database 5.

Step A7. If the users are paid remuneration for content distribution, then on this step payment of the remuneration is performed in accordance with the type of user personal identifier.

Thus, due to the fact that, contrary to the prior art where the user during a cycle of actions can by activating on the exterior web resource a button of social network, for example, distribute (promote) the content of said web resource only by address to a single personal page in the social network which button was activated, in the present Invention activation of the functional element by the described technology allows the user automatically distribute the content on several (more than one) own web resources, for example, on several social networks simultaneously therefore increasing the efficiency of content distribution method, creating a unique data processing system in administrative, commercial, financial, management purposes providing the motivation of efficient content distribution by charging remuneration, and expanding opportunities compared to the known analogues.

We claim:

1. Method for content promoting consisting in user connecting via network by means of user device to distributor web resource in order to distribute the selected content, the method in which a functional element is located on the web resource of the content distributor, after which activation by the user the distributor web resource addresses to a database containing user's web resources parameters which the user is permitted to control and automatically publishes the content selected by the user on several (more than one) user's web resources according to the database parameters.

2. The method of claim. 1, wherein the user may be charged remuneration after publishing the selected content.

3. The method of claim 1, wherein the activation by the user of the functional element is performed by means of keyboard, mouse, touch-screen, trackball, stylus pen, stylus, touch-pad, joystick, stain-gauge joystick, game-pad, or remote control.
